(19) United States
(12) Patent Application Publication
(10) Pub. No.: US 2015/0145846 A1
(43) Pub. Date: May 28, 2015

(54) DISPLAY MEDIUM REWRITING DEVICE, DISPLAY DEVICE, DISPLAY MEDIUM REWRITING METHOD, AND DISPLAY REWRITING PROGRAM

(71) Applicants: FUJIFILM Corportion, Tokyo (JP); FUJI XEROX CO., LTD., Tokyo (JP)

(72) Inventors: Takayuki Takeuchi, Kanagawa (JP); Kenichi Ishizuka, Tokyo (JP); Yasuhiro Shinkai, Tokyo (JP); Yuki Oabe, Tokyo (JP); Toshita Hara, Tokyo (JP)

(73) Assignee: FUJI XEROX CO., LTD., Minato-ku, Tokyo (JP)

(21) Appl. No.: 14/407,392

(22) PCT Filed: Jun. 20, 2013
(86) PCT No.: PCT/JP2013/067000

§ 371 Date: Dec. 11, 2014

(30) Foreign Application Priority Data
Jun. 22, 2012 (JP) 2012-140929

(51) Int. Cl. G09G 3/20; G06K 7/10; B41J 3/407

(52) U.S. Cl. CPC G09G 3/2096; B41J 3/4076; G06K 7/10158; G09G 2370/16
USPC 345/211

(57) ABSTRACT

An object is to display and erase an image on a display medium both conveniently and safely. Data is written to electronic paper by placing the electronic paper is on a rewriting device together with an IC card. When, in this state, the IC card is then removed, the displayed image is retained by the electronic paper until a predetermined condition is fulfilled. Writing of annotations using an electronic pen is possible until the predetermined condition is fulfilled, and the image displayed on the electronic paper by the writing device is erased when the predetermined condition is fulfilled.

### CROSS REFERENCE TO RELATED APPLICATIONS

This is a National Stage of International Application No. PCT/JP2013/067000 filed Jun. 20, 2013, claiming priority based on Japanese Patent Application No. 2012-140929 filed Jun. 22, 2012, the contents of all of which are incorporated herein by reference in their entirety.

TECHNICAL FIELD

The present invention relates to a display medium rewriting device, a display device, a display medium rewriting method, and a display rewriting program.

### BACKGROUND ART

Recently proposals have been made for display devices capable of retaining a displayed image without power supply (so-called electronic paper).

Various forms of display devices have been proposed as such display devices, for example, technology described by Japanese Patent Application Laid-Open No. 2004-021288 (Patent Document 1), Japanese Patent No. 4403161 (Patent Document 2), JP-A No. 2002-092569 (Patent Document 3), JP-A No. 2003-099541 (Patent Document 4), and JP-A No. 2010-015211 (Patent Document 5) has been proposed.

In the technology described by Patent Document 1, a proposal is made for technology that, in addition to IC card common circuit sections that implement common IC card features of contactless IC cards, such as modulation/demodulation circuits, control CPUs, memory, and the like, also connects a display element, with low power consumption capable of continuous display for a fixed period even when power supply is interrupted, to the control CPU through a display driving circuit. The display element is then caused to display data for a fixed period after passing through a reader/writer.

In the technology described by Patent Document 2, a proposal is made for technology in which an RFID data monitor device receives a communication waveform of wireless communication exchanged between an RFID tag and a RFID, and compares it against pre-stored standard data. Matching standard data is acquired as acquisition data, and the acquired standard data is displayed on a liquid crystal display device, and sequentially stored on a hard disk.

In the technology described by Patent Document 3, a proposal is made for technology that operates to achieve similar levels for an electromagnetic coupling state of a reader/writer with a wireless card content display device, and an electromagnetic coupling state of the reader/writer with a wireless card, by exposing the wireless card and the wireless card content display device to the reader/writer in a stacked state. The most recent data is then incorporated by intercepting the intercommunication content between the wireless card and the reader/writer, and the most recent data is displayed on the wireless card content display device using wireless power.

In the technology described by Patent Document 4, a proposal is made for technology of a medical data system set up in a medical facility for displaying medical data for individual patients. The medical data system includes a data storage device that stores medical data, and a portable mobile data display device that displays medical data stored in the data storage device.

In the technology described by Patent Document 5, a proposal is made for technology in a medical practice support system provided with a server that manages a medical data database, and a mobile terminal connected to the server through a network. The mobile terminal is provided with an electronic pen, and a main body section that includes, as operation modes, a handwritten input mode and a data transmission mode. In the handwritten input mode, input of data is received through handwritten operation by a nurse employing the electronic pen, and the received data is displayed on electronic paper placed on the main body section. In the data transmission mode, the received data is transmitted to the server, and the server updates the medical data database based on the data transmitted from the mobile terminal.

### SUMMARY OF INVENTION

### Technical Problem

Electronic paper is able to retain a displayed image without a power supply, enabling electronic paper to be handled similarly to a paper medium.

Thus, employment of electronic paper for electronic patient records as described in Patent Document 4 and Patent Document 5, and employment of electronic paper for various reports, is conceivable.

However, since little consideration has been given to the inconvenience caused by the displayed image simply erasing, there is room for improvement in the technology described by Patent Documents 1 to 5.

In consideration of the above circumstances, an object of the present invention is to display and erase an image on a display medium both conveniently and safely. Solution to Problem

In order to achieve the above object, a display medium rewriting device according to a first aspect of the present invention includes: a detection section that detects the respective presences of a card stored with predetermined identification data and provided with an antenna for transmitting and receiving the identification data, and a display medium that displays an image by using contactless power supply from a supply section and retains displayed images even in a state in which power supply has ceased; the supply section that supplies power to the display medium; and an image rewriting section that controls image rewriting to the display medium such that power is supplied to the display medium by the supply section and an image according to the identification data acquired through the antenna is displayed in cases in which the respective presences of the card and the display medium have been detected by the detection section, and that, in a state in which an image is displayed on the display medium, controls image rewriting to the display medium such that the image is displayed until the presence of the card has ceased to be detected by the detection section and a predetermined erasure condition for erasing images on the display medium has been fulfilled, and the image displayed on the display medium is erased in cases in which the presence of the card has ceased to be detected by the detection section and the erasure condition has been fulfilled.

According to the display medium rewriting device of the first aspect, the card is stored with the predetermined identification data (for example, an ID or the like that specifies a user), and is provided with the antenna that transmits and receives the identification data. The display medium displays the image using the external power supply and retains displayed images even in a state in which power supply has ceased. The detection section detects the respective presences of the card and the display medium.

Moreover, the supply section supplies power to the display medium. Rewriting of an image to be displayed on the display medium is thereby enabled. For example, a contactless power supply method, such as an electromagnetic inductance method, a magnetic resonance method, or an electrolytic coupling method, may be employed, or a contact method of power supply may be employed.

Then, in the image rewriting section, in cases in which the respective presences of the card and the display medium are detected by the detection section, power is supplied to the display medium by the supply section, and image rewriting to the display medium is controlled such that the image according to the identification data acquired through the antenna is displayed. Display of the image on the display medium is thereby enabled.

Moreover, in a state in which an image is displayed on the display medium, the image rewriting section controls image rewriting to the display medium such that the image is displayed until the presence of the card has ceased to be detected by the detection section and the predetermined erasure condition for erasing images on the display medium has been fulfilled, and the displayed image is erased from the display medium in cases in which the presence of the card has ceased to be detected by the detection section and the erasure condition has been fulfilled. Namely, the displayed image is not immediately erased from the display medium, and is displayed until the erasure condition has been fulfilled in cases in which the presence of the card has ceased to be detected. The displayed image is subsequently erased from the display medium when the erasure condition has been fulfilled, enabling the display medium to be handled with greater convenience than in cases in which erasure of the image from the display medium happens immediately after the presence of the card has ceased to be detected. The image on the display medium is erased when the erasure condition has been fulfilled, enabling safety to be assured with respect to data leakage or the like. Convenient and safe display and erasure of the image on the display medium is thereby enabled.

The present invention may be configured, as in a second aspect of the invention, to further include an annotation detection section that detects annotations to the display medium, wherein the image rewriting section further controls image rewriting to the display medium such that, in a state in which an image is displayed on the display medium, an image according to the annotation is displayed on the display medium in cases in which an annotation to the display medium has been detected by the annotation detection section. Display of an annotated image is thereby enabled.

In cases in which the display medium displays an image according to the annotation, as in a third aspect of the present invention, the image rewriting section may further control image rewriting to the display medium such that, in a state in which an image is displayed on the display medium, an image according to the annotation is displayed on the display medium from when the presence of the card has ceased to be detected by the detection section until a predetermined erasure condition for erasing images on the display medium has been fulfilled. Making annotations from when the presence of the card has ceased to be detected until the erasure condition has been fulfilled is thereby enabled.

Moreover, as in a fourth aspect of the invention, a combining saving section may be further included that combines the image displayed on the display medium and the image according to the annotation, and saves the combination image associated with the identification data. As in a fifth aspect of the invention, an image saving section may be further included that saves an image displayed on the display medium and an image according to the annotation associated with the identification data.

As in a sixth aspect of the invention, the image rewriting section may control image rewriting to the display medium such that the image displayed on the display medium is erased in cases in which any of the following conditions have been fulfilled as the erasure condition: cases in which image erasure has been instructed; cases in which a predetermined period has elapsed; cases of movement of the display medium to outside a predetermined range; and cases in which a predetermined time has been reached.

Moreover the present invention may be configured such that, as in a seventh aspect of the invention, in cases in which plural of the display media are disposed superimposed on each other, the supply section supplies power to the uppermost disposed display medium and the image rewriting section controls image rewriting to the uppermost disposed display medium.

The present invention may, as in an eighth aspect of the present invention, be configured as a display device including a card stored with predetermined identification data and provided with an antenna for transmitting and receiving the identification data, a display medium that displays an image using external power supply, and that retains displayed images even in a state in which the power supply has ceased, and the display medium rewriting device described above.

A display medium rewriting method according to a ninth aspect is a display medium rewriting method in which image rewriting to a display medium is performed using a display medium rewriting device that includes a supply section, a detection section, and an image rewriting section, the method including: a detection step that detects the respective presences of a card stored with predetermined identification data and provided with an antenna for transmitting and receiving the identification data, and a display medium that displays an image by using contactless power supply from the supply section and retains displayed images even in a state in which power supply has ceased, using a detection section that detects these presences; and an image rewriting step of performing image rewriting using the image rewriting section, that performs image rewriting to the display medium such that that power is supplied to the display medium and an image according to the identification data acquired through the antenna is displayed on the display medium in cases in which the respective presences of the card and the display medium have been detected by the detection section, and that, in a state in which an image is displayed on the display medium, controls image rewriting to the display medium such that the image is displayed until the presence of the card has ceased to be detected by the detection section and a predetermined erasure condition for erasing images on the display medium has been fulfilled, and the image displayed on the display medium is erased in cases in which the presence of the card has ceased to be detected by the detection section and the erasure condition has been fulfilled.

According to the display medium rewriting method according to the ninth aspect, the card is stored with the predetermined identification data (for example, an ID or the like that specifies a user) and is provided with the antenna that transmits and receives the identification data. The display medium displays the image using external power supply, and retains displayed images even in a state in which power supply has ceased. At the detection step, the detection section moreover detects the respective presences of the card and the display medium.

Moreover, in cases in which the respective presences of the card and the display medium have been detected by the detection section, in the image rewriting step image rewriting to the display medium is performed such that power is supplied to the display medium, and the image according to the identification data acquired through the antenna is displayed on the display medium. Display of the image on the display medium is thereby enabled.

Moreover, in a state in which an image is displayed on the display medium, in the image rewriting step, image rewriting to the display medium is performed such that the image is displayed until the presence of the card has ceased to be detected by the detection section and the predetermined erasure condition for erasing images on the display medium has been fulfilled, and the displayed image is erased from the display medium in cases in which the presence of the card has ceased to be detected by the detection section and the erasure condition has been fulfilled. Namely, in cases in which the presence of the card has ceased to be detected, the displayed image is not immediately erased from the display medium, and is displayed until the erasure condition has been fulfilled. The displayed image is subsequently erased from the display medium when the erasure condition has been fulfilled, enabling the display medium to be handled with greater convenience than in cases in which erasure of the image from the display medium happens immediately after the presence of the card has ceased to be detected. The image on the display medium is erased when the erasure condition has been fulfilled, enabling safety to be assured with respect to data leakage or the like. Convenient and safe display and erasure of the image on the display medium is thereby enabled.

The present invention may be configured, as in a tenth aspect of the invention, as a display rewriting program that causes a computer to function as the image rewriting section of the display medium rewriting device described above. Advantageous Effects of Invention

The present invention as explained above has the excellent advantageous effect of enabling convenient and safe display and erasure of an image on a display medium.

### BRIEF DESCRIPTION OF DRAWINGS

FIG. 1A is a diagram illustrating an example of a display device according to an exemplary embodiment of the present invention.

FIG. 1B is a diagram illustrating an example of a display device according to an exemplary embodiment of the present invention.

FIG. 2 is a diagram outlining a display device according to an exemplary embodiment of the present invention.

FIG. 3 is a block diagram illustrating a configuration of a display device according to an exemplary embodiment of the present invention.

FIG. 4 is a flowchart illustrating an example of a processing flow performed by a rewriting device of a display device according to an exemplary embodiment of the present invention.

FIG. 5 is a flowchart illustrating an example of an annotation processing flow performed by a rewriting device of a display device according to an exemplary embodiment of the present invention.

FIG. 6A is a diagram illustrating an example of a contact-method connection of electronic paper and a rewriting device.

FIG. 6B is a diagram illustrating an example of a contact-method connection of electronic paper and a rewriting device.

### DESCRIPTION OF EMBODIMENTS

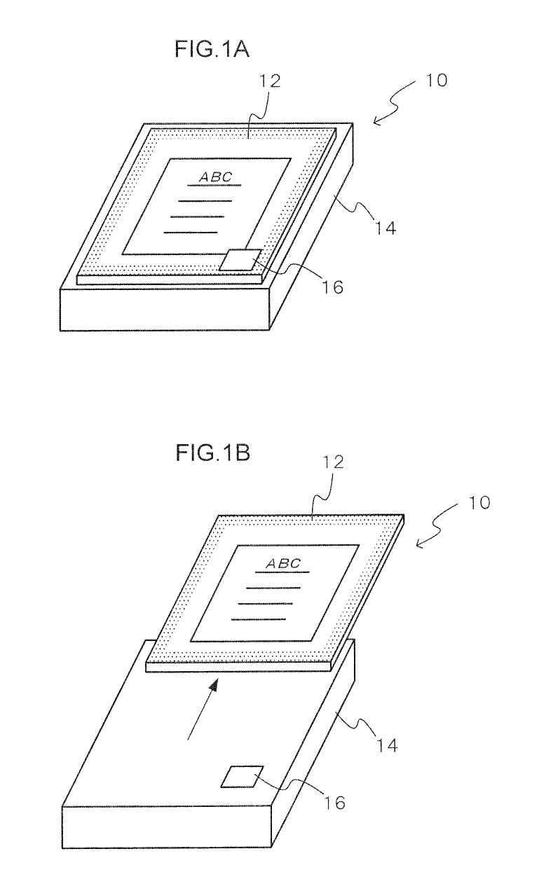

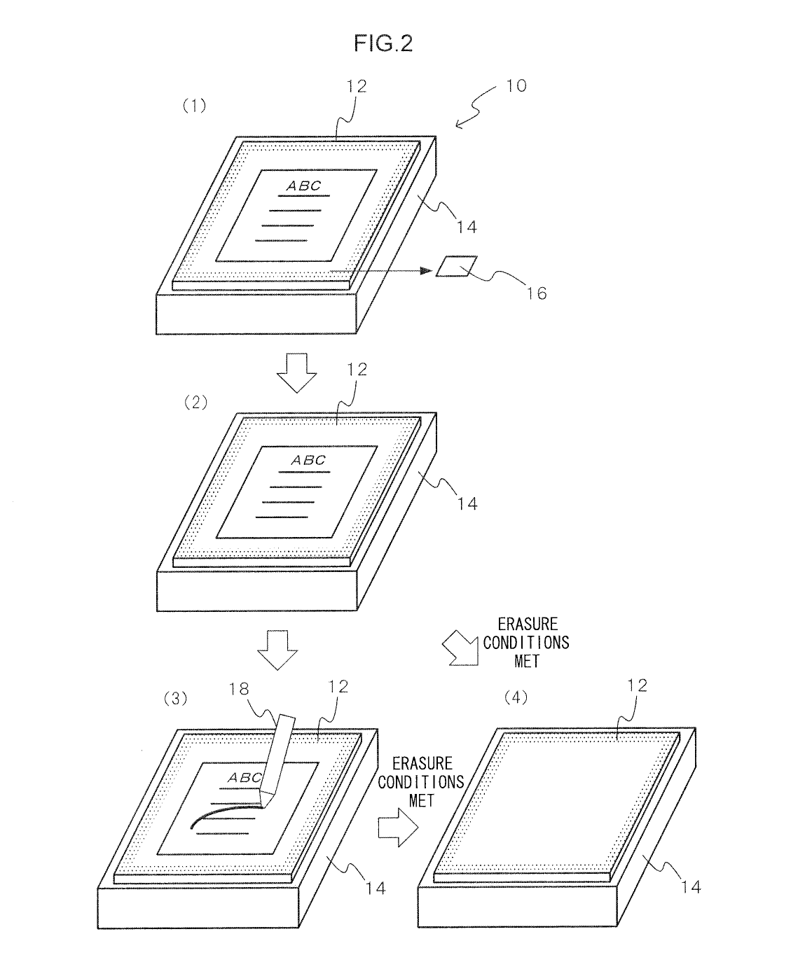

Detailed description is given below regarding an example of an exemplary embodiment of the present invention with reference to the drawings. FIG. 1A and FIG. 1B are diagrams illustrating an example of a display device according to an exemplary embodiment of the present invention, and FIG. 2 is a diagram to schematically explain the display device according to an exemplary embodiment of the present invention.

As illustrated in FIG. 1A and FIG. 1B, a display device 10 according to an exemplary embodiment of the present invention includes electronic paper 12, a rewriting device 14, and an integrated circuit (IC) card 16.

The electronic paper 12 is configured as a memory-type display medium capable of retaining display even without a power source supply. For example, an electrophoresis-type display medium or the like can be applied as the memory-type display medium.

The rewriting device 14 performs writing and erasure of data on the electronic paper 12 when a predetermined condition has been fulfilled. Namely, image display or image erasure on the electronic paper 12 is performed by the rewriting device 14.

The IC card 16 is pre-stored with a card ID, such as user data for identification of a user, and the rewriting device 14 acquires the card ID from the IC card 16, and permits data writing on and erasure from the electronic paper 12 by the rewriting device 14, based on the card ID acquired from the IC card 16.

In the display device 10 according to the present exemplary embodiment, when the electronic paper 12 is placed on the rewriting device 14 together with the IC card 16, as illustrated in FIG. 1A, the rewriting device 14 acquires the card ID from the IC card 16, and identifies the user. Then, rewriting of data of the electronic paper 12 is enabled in a state in which the rewriting device 14 has identified the user.

In the display device 10 according to the present exemplary embodiment, as illustrated in FIG. 1B, the electronic paper 12 and the IC card 16 are placed together on the rewriting device 14 and data rewriting performed, and the electronic paper 12 can be carried with the data written to the electronic paper 12 remaining displayed by removing just the electronic paper 12.

However, in a state in which data has been written to the electronic paper 12 by placing the electronic paper 12 and the IC card 16 together on the rewriting device 14, when the IC card 16 has been removed as illustrated in FIG. 2(1), the displayed image is retained by the electronic paper 12, as illustrated in FIG. 2(2), until a predetermined condition is fulfilled. Moreover, configuration is made to enable handwritten annotations by an electronic pen 18, as illustrated in FIG. 2(3), until the predetermined condition is fulfilled, and such that the rewriting device 14 erases the displayed image from the electronic paper 12, as illustrated in FIG. 2(4), when a predetermined erasure condition has been fulfilled. Examples of the predetermined erasure condition may include: erasure being instructed through the operation of an erase button or the like by a user; a preset period elapsing according to a timer or the like; when a position detection means (such as a mechanism that detects a nearby communications access point such as a public line base station access point such as global positioning system (GPS) or third generation mobile telecommunications system (3G), wireless fidelity (WiFi), or Bluetooth) is provided to the rewriting device 14, the rewriting device 14 and the electronic paper 12 moving outside of a predetermined range; or a predetermined scheduled time being reached.

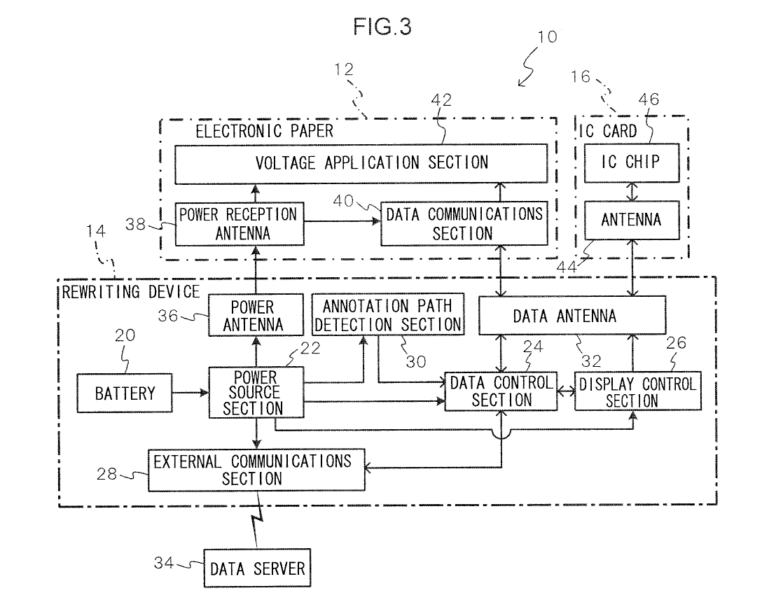

Detailed explanation follows regarding the configuration of the display device 10 according to the exemplary embodiment of the present invention. FIG. 3 is a block diagram illustrating the configuration of the display device 10 according to the exemplary embodiment of the present invention.

The rewriting device 14 is provided with a battery 20 to supply power to a power source section 22 that supplies power to each section of the rewriting device 14, and the power source section 22 respectively supplies power supplied from the battery 20 to a data control section 24, a display control section 26, an external communications section 28, and an annotation path detection section 30. A power antenna 36 performs contactless supply of power from the rewriting device 14 to the electronic paper 12.

The data control section 24 is respectively connected to the external communications section 28, the display control section 26, and a data antenna 32, and, in addition to controlling each section, controls rewriting of the image on the electronic paper 12 based on ID data of the IC card 16 (a card ID), ID data of the electronic paper 12 (an electronic paper ID), or the like. Specifically, the data control section 24 controls the display control section 26 so as to display an image corresponding to the card ID on the electronic paper 12 when a card ID and an electronic paper ID have been detected, and when a card ID has ceased to be detected and the predetermined erasure condition has been fulfilled in such a state, the display control section 26 is controlled so as to erase the displayed image on the electronic paper 12.

The external communications section 28 is capable of wireless communication with an external data server 34 or the like, and acquires image data from the data server 34 for display on the electronic paper 12. The display control section 26 controls writing and erasure of an image on the electronic paper 12 by transmitting image data to the electronic paper 12 through the data antenna 32. Namely, the data control section 24 controls the display control section 26 and the data antenna 32 so as to display an image on the electronic paper 12, based on image data acquired by the external communications section 28. In the present exemplary embodiment, image data corresponding to the card ID is acquired from the data server 34, and displayed on the electronic paper 12.

When an annotation operation is performed on the electronic paper 12 by the electronic pen 18 (see FIG. 2), the annotation path detection section 30 detects the path of the electronic pen 18, and transmits the detection result to the data control section 24. The data control section 24 thereby controls the display control section 26 to display an annotation image that represents the annotations to the electronic paper 12. Detection of an annotation operation by the electronic pen 18 may, for example, be by detection of the path of the electronic pen 18 through electromagnetic induction.

The annotation image annotated by the electronic pen may be saved on the data server 34 as a combined image that is combined with the original image displayed on the electronic paper 12, associated with the card ID corresponding to the original image, the annotation image may be saved on the data server 34 as a separate layer associated with the card ID corresponding to the original image, or the combined image, the original image, and the annotation image may each be saved on the data server 34, associated with the card ID.

When placed on the rewriting device 14, the electronic paper 12 collects power supplied from the power antenna 36 of the rewriting device 14 through a power collection antenna, and is driven with the collected power as a power source. As the method of power supply between the power antenna 36 of the rewriting device 14, and the power collection antenna of the electronic paper 12, for example, any out of an electromagnetic inductance method, a magnetic resonance method, or an electric field coupling method may be applied.

Image data transmitted from the data antenna 32 of the rewriting device 14 is received by a data communications section 40, and output to electrodes, not illustrated in the drawings, provided to the electronic paper 12 in a voltage application section that applies voltage to display images.

A voltage application section 42 controls to display an image on the electronic paper 12 by applying a voltage to respective electrodes, not illustrated in the drawings, corresponding to respective pixels, based on the image data received from the rewriting device 14.

The IC card 16 is provided with an antenna 44, and an IC chip 46, and the IC chip 46 is stored with, for example, ID data that specifies a user, and the data stored in the IC chip 46 is transmitted to the rewriting device 14 by wireless communication between the data antenna 32 and the antenna 44. The wireless communication between the antenna 44 of the IC card 16 and the data antenna 32 of the rewriting device 14 may, for example, employ the 13.56 MHz band, or may employ the 4.48 GHz band.

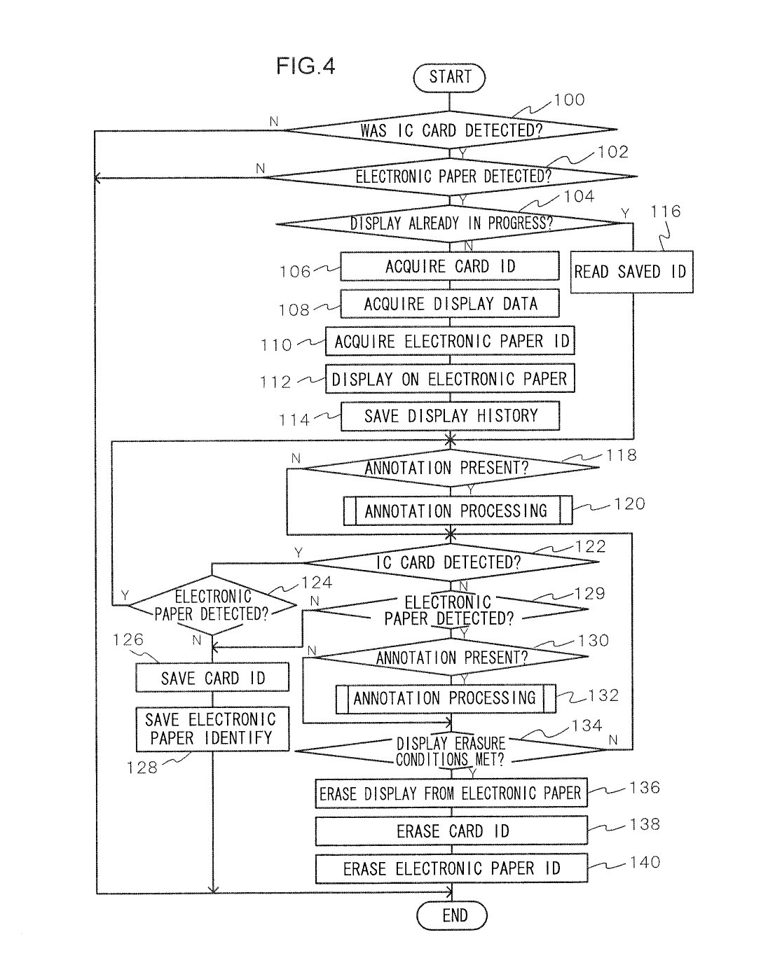

Explanation next follows regarding a specific flow of processing performed by the rewriting device 14 of the display device 10 according to the exemplary embodiment of the present invention configured as described above. FIG. 4 is a flowchart illustrating an example of a processing flow performed by the rewriting device 14 in the display device 10 according to the exemplary embodiment of the present invention.

Whether or not an IC card has been detected is determined at step 100. This determination is determination as to whether or not communication has been established by the data antenna 32 with the antenna 44 of the IC card 16 or the like, and processing transitions to step 102 when this determination is affirmative, and processing ends when this determination is negative.

Whether or not the electronic paper 12 has been detected is determined at step 102. Such determination is a determination as to whether or not communication has been established by the data antenna 32 with the data communications section 40 of the electronic paper 12 or the like, and processing transitions to 104 when this determination is affirmative, and processing ends when negative.

When the IC card 16 and the electronic paper 12 have been detected, then determination is made at step 104 as to whether or not the electronic paper 12 is already displaying. This determination is determination as to whether or not later stage processing has already been performed and an image has been written to the electronic paper 12 by the rewriting device 14, and the card ID and the electronic paper ID have been saved. Processing transitions to step 106 when this determination is negative, and processing transitions to step 116 when affirmative.

At step 106, the card ID of the IC card 16 is acquired, and transition is made to step 108. Namely, the card ID stored on the IC chip 46 is acquired by the data control section 24, through the antenna 44 and the data antenna 32.

At step 108, display data is acquired and transition is made to step 110. In the present exemplary embodiment, the data control section 24 acquires display data corresponding to the card ID from the data server 34 through the external communications section 28.

At step 110, the electronic paper ID is acquired from the electronic paper 12 and transition is made to step 112. Namely, an electronic paper ID, pre-stored in the data communications section 40 or the like, is acquired by the data control section 24 through the data communications section 40, and the data antenna 32.

At step 112, display on the electronic paper 12 is performed, and transition is made to step 114. Namely, due to the display control section 26 transmitting the display data acquired at step 108 to the electronic paper 12, display on the electronic paper 12 is performed by the voltage application section 42 applying a voltage based on the display data.

At step 114, display history is saved, and transition is made to step 118. The display history is stored as history of who has performed what kind of display on which electronic paper 12, for example by associating and storing the card ID, the electronic paper ID, and the display data. Note that the card ID and the electronic paper ID alone may be stored as history.

At step 116, since this is a state in which the electronic paper 12 has been replaced on the rewriting device 14 in a state while already displaying, the saved ID (the card ID and the electronic paper ID) is read, and processing transitions to step 118.

At step 118, whether or not an annotation to the electronic paper 12 has been performed is determined. This determination is determination as to whether or not an annotation operation has been performed by the electronic pen 18 or the like, and is determined in a state in which both the electronic paper 12 and the IC card 16 have been placed on the rewriting device 14. Transition is made to step 120 when this determination is affirmative, and transition is made to step 112 when negative.

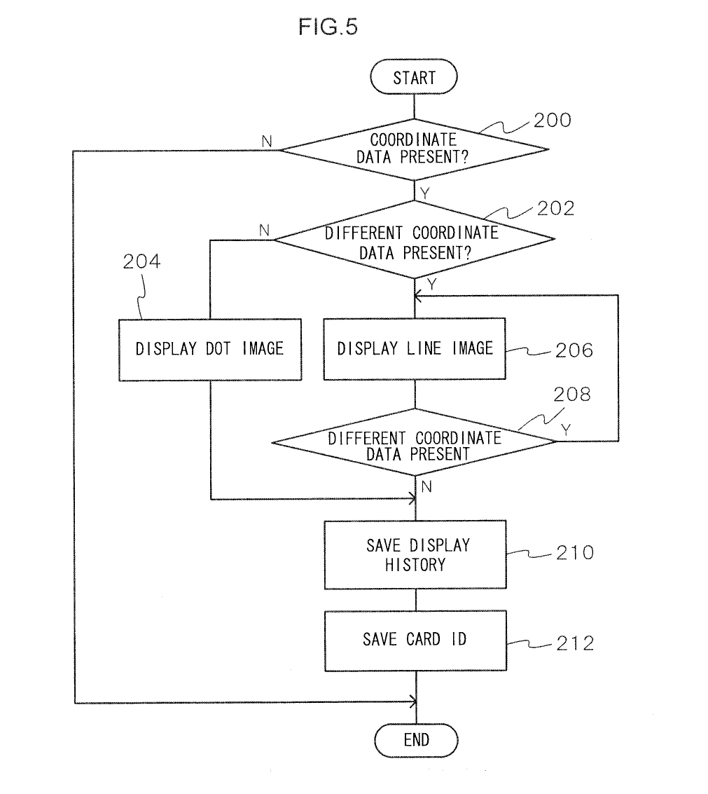

At step 120, annotation processing is performed and transition is made to step 122. Detailed explanation follows regarding the annotation processing. FIG. 5 is a flowchart illustrating an example of annotation processing flow performed by the rewriting device of the display device according to the exemplary embodiment of the present invention.

First, when transition has been made to annotation processing, whether or not coordinate data is present is determined at step 200. This determination is detection of whether or not the electronic pen 18 has been detected by the annotation path detection section 30, and whether or not coordinate data thereof is present. Processing ends when this determination is negative, and processing transitions to step 202 when affirmative.

At step 202, whether or not different coordinate data is present is determined. Namely, after detection of the coordinate data by the annotation path detection section 30, determination is made as to whether or not the electronic pen 18 has been moved and different coordinate data has been detected. Processing transitions to step 204 when this determination is negative, and processing transitions to step 206 when affirmative.

At step 204, dot image display is performed, and processing transitions to step 210. Namely, an image according to the annotation is displayed by the display control section 26 controlling display on the electronic paper 12 so as to display dots at locations corresponding to the coordinate data.

At step 206, line image display is performed, and transition is made to step 208. Namely, an image according to the annotation is displayed by the display control section 26 controlling display on the electronic paper 12 so as to display lines at locations corresponding to the path of the electronic pen 18

At step 208, whether or not different coordinate data is present is re-determined. Namely, whether or not the line image is being continued further is determined, and when this determination is affirmative processing transitions to step 206 and the display control section 26 controls display on the electronic paper 12 so as to display the corresponding line image. When this determination is negative, transition is made to step 210.

At step 210, the display history is saved to the data server 34, and transition is made to step 212.

At step 212, the card ID is saved to the data server 34 and a cycle of annotation processing ends. Note that the display history is saved associated with the card ID. As described above, the annotation image to be saved may be saved on the data server 34 associated with the card ID corresponding to the original image as a combined image that is combined with the original image displayed on the electronic paper 12. The annotation image may be saved on the data server 34 associated with the card ID corresponding to the original image as a separate layer. A combined image, the original image, and the annotation image may be respectively saved on the data server 34, associated with the card ID.

When annotation processing has ended, determination is made at step 112 as to whether or not an IC card has been detected. Processing transitions to step 124 when this determination is affirmative, and processing transitions to step 129 when negative.

At step 124, determination is made as to whether or not the electronic paper 12 has been detected. Processing returns to step 118 and the above processing repeated when this determination is affirmative, and processing transitions to step 126 when negative.

At step 126, the card ID is saved in the data control section 24, transition is made to step 128, and the electronic paper ID is saved and processing ends. Namely, when just the electronic paper 12 is removed from the rewriting device 14, the electronic paper 12 is carried by the user in a state in which an image displayed on the electronic paper 12 is maintained. Then, when image writing is performed again or erasure is performed, the above step 104 is affirmative, and the card ID and the electronic paper ID are read by placing the electronic paper 12 on the rewriting device 14.

At step 129, determination is made as to whether or not the electronic paper 12 has been detected, and processing transitions to the above step 126 when this determination is negative. Namely, when the IC card 16 and the electronic paper 12 are both taken away at the same time, similarly to the above case in which just the electronic paper 12 was removed, the electronic paper 12 is carried around by the user in a state in which an image displayed on the electronic paper 12 is maintained. Then, when image writing is performed or erasure of the image is performed, the above step 104 is affirmative, and the card ID and the electronic paper ID are read by placing the electronic paper 12 on the rewriting device 14.

Transition is made to step 130 when affirmative determination has been made at step 129, and at step 130, determination is made as to whether or not annotation to the electronic paper 12 has been performed. This determination is determination as to whether or not the IC card 16 has been removed from the rewriting device 14 and an annotation operation has been performed by the electronic pen 18 or the like. Processing transitions to step 132 when this determination is affirmative, and processing transitions to step 134 when this determination is negative.

At step 132, the above annotation processing is performed, and transition is made to step 134. Note that the annotation processing is performed according to the flowchart of FIG. 5 as described above.

At step 134, determination is made as to whether or not the predetermined display erasure condition has been fulfilled. This determination is, for example, determination as to whether or not erasure has been instructed by a user, whether or not a preset period has elapsed, whether or not the rewriting device 14 and the electronic paper 12 have moved out a predetermined range, or whether or not a predetermined scheduled time has been reached. Processing returns to step 122 and the above processing is repeated when this determination is negative, and processing transitions to step 136 when this determination is affirmative.

At step 136, the display is erased from the electronic paper 12, and processing transitions to step 138. Namely, the display is erased from the electronic paper 12 due to the display control section 26 transmitting data to erase to the electronic paper 12, and the voltage application section 42 applying a voltage based on this data.

At step 138, the card ID is erased and processing transitions to step 140, and the electronic paper ID is erased, and one cycle of the processing is ended.

Thus, in the present exemplary embodiment, since the display of the electronic paper 12 is not erased immediately the IC card has ceased to be detected and erasure is performed when the predetermined erasure condition has been fulfilled, annotations and the like are possible until the displayed image is erased from the electronic paper 12, and convenient handling is enabled.

The displayed image is also erased from the electronic paper 12 when the IC card 16 has ceased to be detected and the erasure condition has been fulfilled, enabling safety to be assured with respect to data leakage. At this stage the displayed image is retained on the electronic paper 12 from when the IC card 16 has ceased to be detected until the erasure condition is fulfilled, enabling the electronic paper 12 to be handled with greater convenience than in cases in which erasure happens immediately.

Accordingly, the display device 10 according to the present exemplary embodiment enables display and erasure of the image on the electronic paper 12 to be performed conveniently and safely.

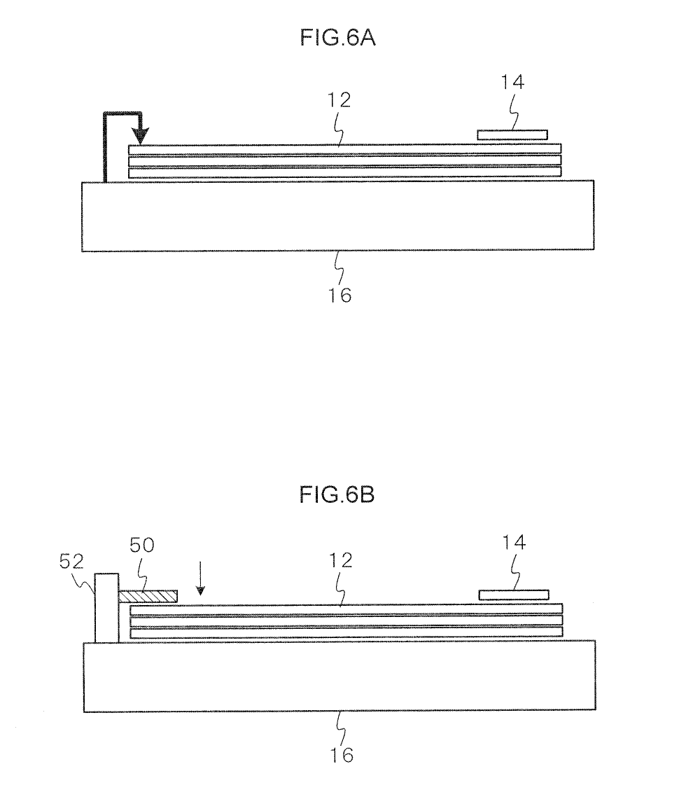

Note that although explanation of the above exemplary embodiment has been given of an example in which power supply and data communication are performed by contactless connection between the rewriting device 14 and the electronic paper 12, there is no limitation thereto, and power supply and data communication may be performed with the rewriting device 14 and the electronic paper 12 electrically connected in contact with each other as indicated by the arrow in FIG. 6A. In the example of FIG. 6A, an example is illustrated in which plural sheets of the electronic paper 12 are placed on the rewriting device 14, and power supply and data communication are performed by making contact with the uppermost electronic paper 12. To implement this, for example as illustrated in FIG. 6B, an example is illustrated in which a holding portion 52 is provided that holds a terminal 50 to electrically connect the electronic paper 12 and the rewriting device 16 together. Configuration is made such that the terminal 50 is movable with respect to the holding portion 52 and biased in the direction of the arrow in FIG. 6B by a biasing means such as a spring. The terminal 50 contacts the uppermost electronic paper 12 by placing plural of the electronic paper 12 interposed between the terminal 50 and the rewriting device 14, enabling power supply and data communication.

The processing illustrated in each flowchart in the above exemplary embodiment may be distributed as a program stored on various recording media types.

The entire content of Japanese patent application number 2012-140929 is incorporated in the present specification by reference.

All cited documents, patent applications and technical standards mentioned in the present specification are incorporated by reference in the present specification to the same extent as if the individual cited document, patent application, or technical standard was specifically and individually indicated to be incorporated by reference.

1-10. (canceled)

11. A display medium rewriting device comprising:
a detection section that detects the respective presences of a card stored with predetermined identification data and provided with an antenna for transmitting and receiving the identification data, and a display medium that displays an image by using contactless power supply from a supply section and retains displayed images even in a state in which power supply has ceased;
the supply section that supplies power to the display medium; and
an image rewriting section that controls image rewriting to the display medium such that power is supplied to the display medium by the supply section and an image according to the identification data acquired through the antenna is displayed in cases in which the respective presences of the card and the display medium have been detected by the detection section, and that, in a state in which an image is displayed on the display medium, controls image rewriting to the display medium such that the image is displayed until the presence of the card has ceased to be detected by the detection section and a predetermined erasure condition for erasing images on the display medium has been fulfilled, and the image displayed on the display medium is erased in cases in which the presence of the card has ceased to be detected by the detection section and the erasure condition has been fulfilled.

12. The display medium rewriting device of claim 11, further comprising:
an annotation detection section that detects annotations to the display medium; wherein
the image rewriting section further controls image rewriting to the display medium such that, in a state in which an image is displayed on the display medium, an image according to the annotation is displayed on the display medium in cases in which an annotation to the display medium has been detected by the annotation detection section.

13. The display medium rewriting device of claim 12, wherein the image rewriting section further controls image rewriting to the display medium such that, in a state in which an image is displayed on the display medium, an image according to the annotation is displayed on the display medium from when the presence of the card has ceased to be detected by the detection section until a predetermined erasure condition for erasing images on the display medium has been fulfilled.

14. The display medium rewriting device of claim 12 further comprising a combining saving section that combines the image displayed on the display medium and the image according to the annotation, and saves the combination image associated with the identification data.

15. The display medium rewriting device of claim 12, further comprising an image saving section that saves the image displayed on the display medium and the image according to the annotation associated with the identification data.

16. The display medium rewriting device of claim 11, wherein the image rewriting section controls image rewriting to the display medium such that the image displayed on the display medium is erased in cases in which any of the following conditions have been fulfilled as the erasure condition: cases in which image erasure has been instructed; cases in which a predetermined period has elapsed; cases of movement of the display medium to outside a predetermined range; and cases in which a predetermined time has been reached.

17. The display medium rewriting device of claim 11, wherein in cases in which a plurality of the display media are disposed superimposed on each other the supply section supplies power to the uppermost disposed display medium and the image rewriting section controls image rewriting to the uppermost disposed display medium.

18. A display device comprising:
a card stored with predetermined identification data and provided with an antenna for transmitting and receiving the identification data;
a display medium that displays an image using external power supply, and that retains displayed images even in a state in which the power supply has ceased; and
the display medium rewriting device of claim 11.

19. A display medium rewriting method that is a display medium rewriting method in which image rewriting to a display medium is performed using a display medium rewriting device that includes a supply section, a detection section, and an image rewriting section, the method comprising:
a detection step that detects the respective presences of a card stored with predetermined identification data and provided with an antenna for transmitting and receiving the identification data, and a display medium that displays an image by using contactless power supply from the supply section and retains displayed images even in a state in which power supply has ceased, using a detection section that detects these presences; and
an image rewriting step of performing image rewriting using the image rewriting section, that performs image rewriting to the display medium such that that power is supplied to the display medium and an image according to the identification data acquired through the antenna is displayed on the display medium in cases in which the respective presences of the card and the display medium have been detected by the detection section, and that, in a state in which an image is displayed on the display medium, controls image rewriting to the display medium such that the image is displayed until the presence of the card has ceased to be detected by the detection section and a predetermined erasure condition for erasing images on the display medium has been fulfilled, and the image displayed on the display medium is erased in cases in which the presence of the card has ceased to be detected by the detection section and the erasure condition has been fulfilled.

20. A non-transitory computer readable storage medium storing a display rewriting program that causes a computer to function as the image rewriting section of the display medium rewriting device of claim 11.

21. A display device comprising:
a card stored with predetermined identification data and provided with an antenna for transmitting and receiving the identification data;
a display medium that displays an image using external power supply, and that retains displayed images even in a state in which the power supply has ceased; and
the display medium rewriting device of claim 12.

22. A display device comprising:
a card stored with predetermined identification data and provided with an antenna for transmitting and receiving the identification data;
a display medium that displays an image using external power supply, and that retains displayed images even in a state in which the power supply has ceased; and
the display medium rewriting device of claim 13.

23. A non-transitory computer readable storage medium storing a display rewriting program that causes a computer to function as the image rewriting section of the display medium rewriting device of claim 12.

24. A non-transitory computer readable storage medium storing a display rewriting program that causes a computer to function as the image rewriting section of the display medium rewriting device of claim 13.
